(19) United States
(12) Patent Application Publication
(10) Pub. No.: US 2007/0011442 A1
(43) Pub. Date: Jan. 11, 2007

(54) Systems and methods of providing indexed load and store operations in a dual-mode computer processing environment

(75) Inventor: Zahid Hussain, Ascot (GB)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies, Inc.

(21) Appl. No.: 11/175,229

(22) Filed: Jul. 6, 2005

(51) Int. Cl. G06F 9/44

(52) U.S. Cl. 712/222

(57) ABSTRACT

The methods, systems, and apparatus improve performance in a computer system by providing indexed load/store instructions for processor operations having indexed or indirect operations in a processing environment that supports both horizontal mode and vertical mode processing.

### TECHNICAL FIELD

The present disclosure generally relates to computer systems, and more particularly to methods and systems for providing indexed or indirect load and store operations in a computer environment utilizing vertical and horizontal processing modes.

### BACKGROUND

As is known, to improve the efficiency of multi-dimensional computations, Single-Instruction, Multiple Data (SIMD) architectures have been developed. A typical SIMD architecture enables one instruction to operate on several operands simultaneously. In particular, SIMD architectures take advantage of packing many data elements within one register or memory location. With parallel hardware execution, multiple operations can be performed with one instruction, resulting in significant performance improvement and simplification of hardware through reduction in program size and control. Traditional SIMD architectures perform mainly “vertical” operations where the corresponding elements in separate operands are operated upon in parallel and independently.

Although many applications currently in use can take advantage of such vertical operations, there are a number of important applications, which require the rearrangement of the data-elements before vertical operations can be implemented so as to provide realization of the application. Exemplary applications include many of those frequently used in graphics and signal processing. In contrast with those applications that benefit from vertical operations, many applications are more efficient when performed using horizontal mode operations.

For example, in many operations, the performance of a graphics pipeline is enhanced by utilizing vertical processing techniques, where portions of the graphics data are processed in independent parallel channels. Other operations, however, benefit from horizontal processing techniques where blocks of graphics data are processed in a serial manner. The use of both vertical mode and horizontal mode processing, also referred to as dual mode, presents challenges in data loading and storing operations. The challenges are amplified with the application of indexed or indirect operations where the operands are processed as relative address locations. For example, indexed operations generally require one or more separate operations to accomplish an otherwise basic load or store operation. For at least these reasons, the above-discussed computer processing functions are data and instruction intensive and therefore will realize improved efficiencies from systems, methods and apparatuses for providing indexed load and store operations in a dual mode computer processing environment.

### SUMMARY

Embodiments of the present disclosure provide a computer system, comprising: array logic configured to store a plurality of vectors, wherein each the plurality of vectors comprises a horizontal array; index logic configured to store offset data, relative to a base address, corresponding to each of the plurality of vectors; loading logic configured to retrieve each of the plurality of vectors; transposition logic configured to transpose the plurality of vectors into a vertical configuration using the offset data; and register logic configured to receive the plurality of vectors, wherein each of the plurality of vectors comprises a vertical array.

Embodiments of the present disclosure can also be viewed as providing methods of indexed loading in a dual mode computer processor, comprising: retrieving a plurality of vectors from an array, the array comprising a plurality of array rows and a plurality of array columns and the array configured to store each of the plurality of vectors in one of the plurality of array rows; generating a plurality of offset values, each of the plurality of offset values corresponding to a position of one of the plurality of rows relative to a base address; transposing the plurality of vectors into a vertical orientation utilizing the plurality of offset values; and storing the transposed plurality of vectors, wherein each of the plurality of vectors is configured as a corresponding one of a plurality of columns.

Embodiments of the present disclosure can also be viewed as providing a computer processing apparatus for loading indexed operations in a dual mode processing environment comprising: a data array, having at least one dimension, configured to store a plurality of data sets; an index register configured to store a plurality of offset values corresponding to an address within the data array; an accumulator configured to receive the plurality of data sets from the array; and a destination register configured to receive the plurality of data sets in a transposed configuration.

Embodiments of the present disclosure can also be viewed as providing computer hardware for loading indexed operations in a dual mode processing environment, comprising: a means for storing a plurality vectors in a first register, wherein each of the vectors comprises a plurality of components and wherein the plurality of components are vertically oriented; a means for retrieving the plurality of vectors from the first register; a means for generating a plurality of offset values corresponding to the plurality of vectors; and a means for receiving the plurality of vectors into a second register, wherein each of the plurality of components within each of the plurality of vectors is received utilizing the corresponding one of the plurality of offset values.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of a conventional graphics pipeline, as is known in the prior art.

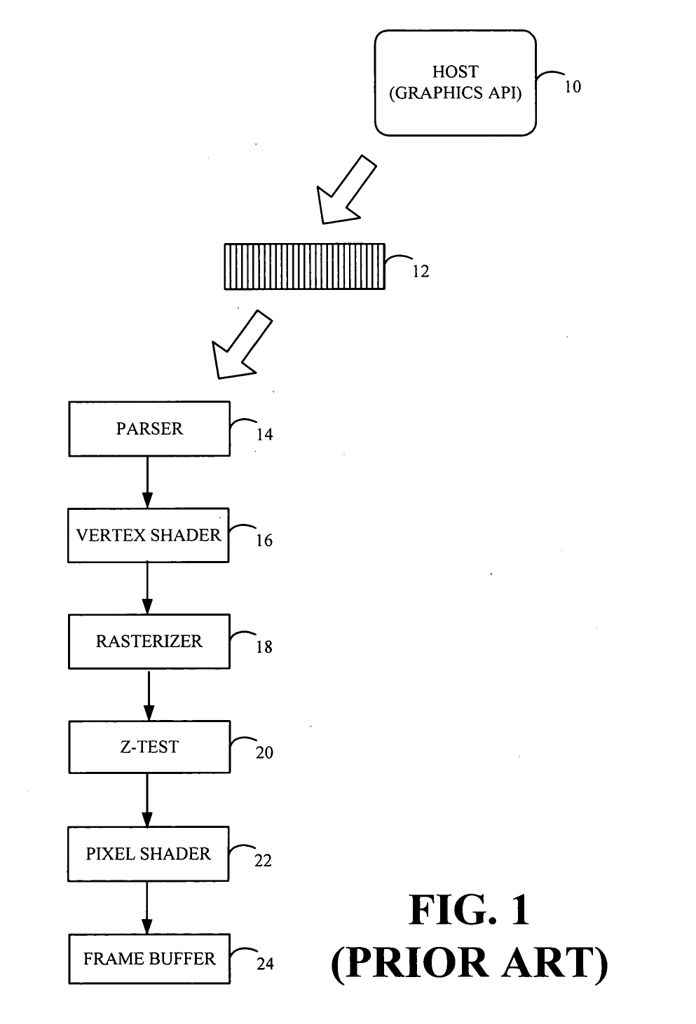

FIG. 2 is a block diagram illustrating an exemplary system for performing indexed load and store operations.

FIG. 3 is a block diagram illustrating an exemplary computer processing apparatus as disclosed herein.

FIG. 4 is a block diagram illustrating an embodiment of indexing as a horizontal operation.

FIG. 5 is a block diagram illustrating an embodiment of an indexed register load operation.

FIG. 6 is a block diagram illustrating an embodiment of an indexed register load operation illustrating a vertical operation from a register file.

FIG. 7 is a block diagram illustrating another embodiment of an indexed register load operation.

FIG. 8 is a block diagram illustrating an embodiment of an indexed register store operation.

FIG. 9 is a block diagram illustrating an exemplary method as disclosed herein.

FIG. 10 is a block diagram illustrating exemplary computer hardware as disclosed herein.

### DETAILED DESCRIPTION

Having summarized various aspects of the present disclosure, reference will now be made in detail to the description of the disclosure as illustrated in the drawings. While the disclosure will be described in connection with these drawings, there is no intent to limit it to the embodiment or embodiments disclosed herein. On the contrary, the intent is to cover all alternatives, modifications and equivalents included within the spirit and scope of the disclosure as defined by the appended claims.

It is noted that the drawings presented herein have been provided to illustrate certain features and aspects of the embodiments of the disclosure. It will be appreciated from the description provided herein that a variety of alternative embodiments and implementations may be realized, consistent with the scope and spirit of the present disclosure.

As summarized above, the present application is directed to embodiments of apparatus, systems and methods of providing indexed load and store operations in a dual mode computer environment. Although exemplary embodiments are presented in the context of a computer graphics system, one of ordinary skill in the art will appreciate that the apparatus, systems and methods herein are applicable in any computer system using vertical mode and horizontal mode processing.

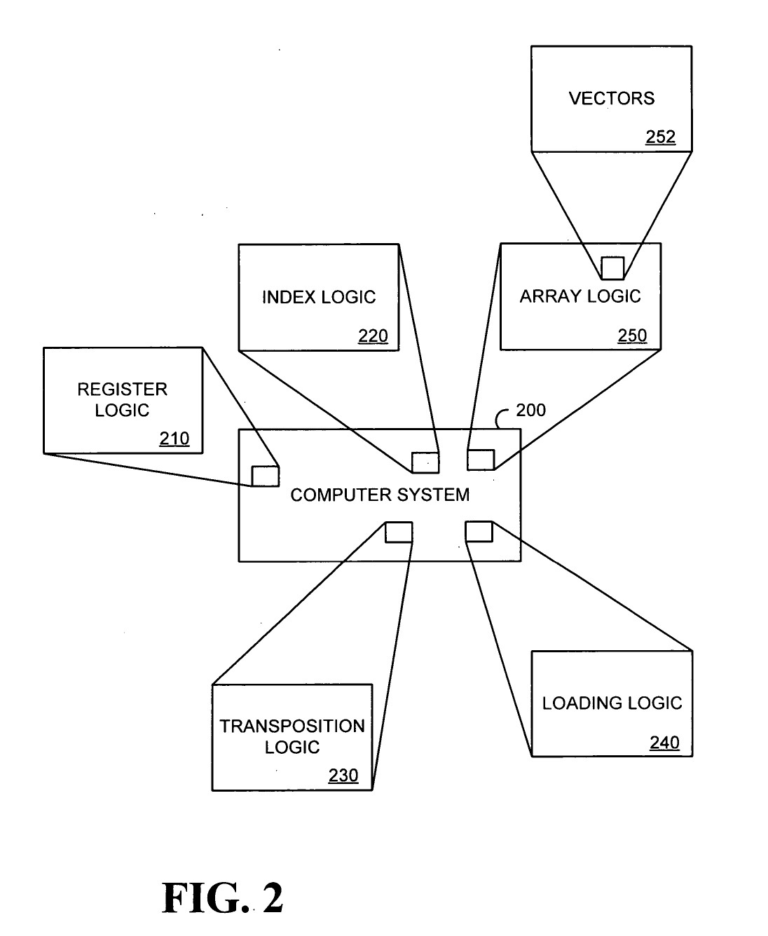

Reference is briefly made to FIG. 2, which is a block diagram illustrating an exemplary system 200 for performing indexed load and store operations of the present disclosure. The system 200 is implemented in a computer system or similar processing device. In some embodiments, the system 200 may be implemented in a graphics processing system, but one of ordinary skill in the art will appreciate that the systems and methods disclosed herein are not limited to graphics processing. The system 200 includes register logic 210 for providing temporary data storage and management. Generally, registers represent a storage area on a processor, for example, for storing information, including control/status information, integer data, floating point data, and packed data. Index logic 220 is provided for storing and managing the offset data associated with relative addressing. Transposition logic 230 is provided to convert data from one orientation to another orientation in a dual mode environment. For example, horizontally configured or oriented data may be transposed to a vertical configuration or orientation. In the context of multiple vectors that are grouped together to form a data matrix, the transposition is performed by interchanging the rows and columns of the data matrix. Loading logic 240 is provided to retrieve data from a data array, which is provided by array logic 250. The array logic 252 includes vectors 250 that are configured, in some embodiments, in a horizontal orientation.

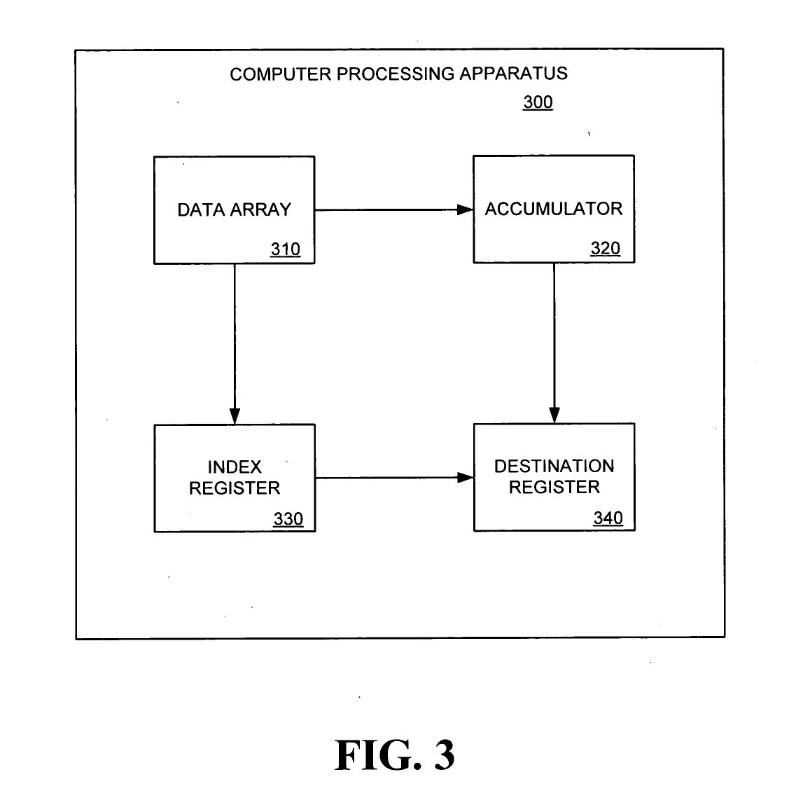

Reference is briefly made to FIG. 3, which is a block diagram illustrating an exemplary computer processing apparatus as disclosed herein. An embodiment of the computer processing apparatus 300 includes a data array 310 configured to store, for example, vector data. The vector data in some embodiments is accessed using relative addressing, also referred to as indexed or indirect addressing. The vector data is received by an accumulator 320 in preparation of subsequent processing. The accumulator 320 may be an actual memory location or, in the alternative, may be achieved within logic inside the computer processing apparatus 300. An index register 330 contains the offset data associated with the indexed addresses of the vector data received by the accumulator 320. Also provided is a destination register 340 for receiving the vector data from the accumulator 320 in conjunction with the offset data stored in the index register 330.

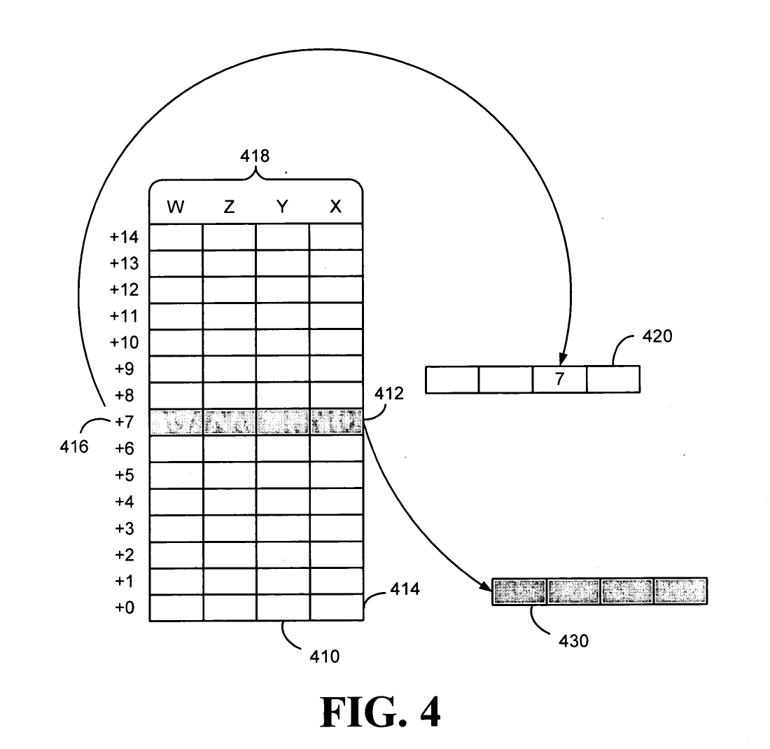

Reference is now made to FIG. 4, which is a block diagram illustrating an embodiment of indexed loading as a horizontal operation. Data is stored in an array 410 in anticipation of subsequent processing. The array 410 of some embodiments is a constant buffer array for storing vector data corresponding a computer graphics process. The vector data includes, for example, coefficient values for each of the dimensions 418 of the vector. One of ordinary skill in the art knows or will know that the array 410 could be utilized for storing data for many different applications and in various stages of processing. An exemplary vector 412, which is stored in the array 410, is shown as having a corresponding offset value 416 of +7. The offset value 416 represents the number of address lines in the array 410 that the corresponding vector is located above a base address 414. A base address 414 is a fixed address that is utilized in conjunction with one or more offset values for defining an effective address. Although the base address 414 may be a fixed address location in the array, alternatively, it may be selected and fixed relative to the specific set of data being processed. The offset value 416 is stored in an index register 420 for use in determining the effective address of the vector 412 within the array 410. A destination register 430 is provided to receive the vector data from the array 410. In this illustration, the array 410 and the destination register 430 are both configured in a horizontal orientation for horizontal mode processing.

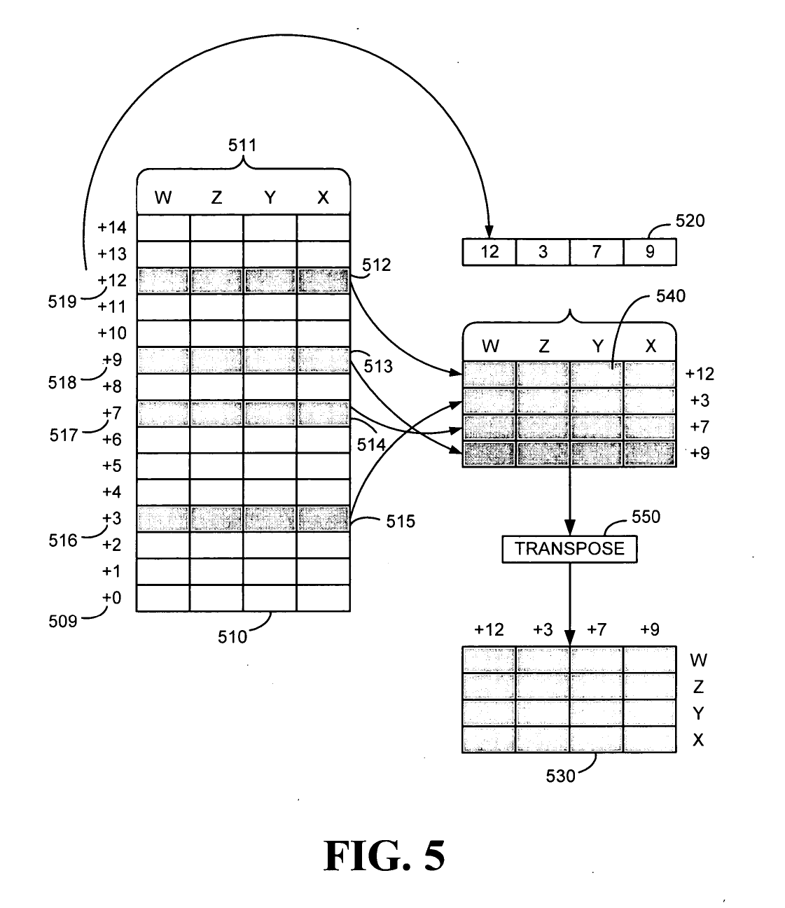

Reference is now made to FIG. 5, which is a block diagram illustrating an embodiment of an indexed register load operation. Data is stored in an array 510 for subsequent processing. The array 5 10 of some embodiments is a constant buffer array for storing vector data corresponding to a computer graphics process. The vector data includes, for example, coefficient values for each of the dimensions 511 of the vector. Exemplary vectors 512, 513, 514, and 515 are stored in the array 510 and are shown having corresponding offset values 516, 517, 518, and 519 of +3, +7, +9, and +12 respectively. The offset values 516-519 are the number of address lines above the base value 509 that the corresponding vector locations are located in the array 510. For example, the vector 515 is three lines above the base address so the corresponding offset value 516 equals positive three. The offset values 516-519 are determined from an index register 520 for use in calculating the effective addresses of the vectors 512, 513, 514, and 515 in the array 510. Although the offset values 516-519 are illustrated as having positive values, one of ordinary skill in the art knows or will know that negative offset values are contemplated within the scope and spirit of this disclosure.

An accumulator 540 is provided for collecting the vectors 512-515. The accumulator 540 is configured such that the vectors 512-515 remain in the same horizontal orientation as when stored in the array 510. As discussed above, the accumulator 520 may be a memory location or may be achieved in logic within a processor. Transposition logic 550 is applied to the accumulated vector data to generate a vertical orientation for loading and storage in the destination register 530. The vertical orientation or configuration in the destination register 530 is such that each column shares the offset value that corresponds to a particular vector and each row constitutes a different vector component. In an embodiment, each column constitutes data provided for a single process, also referred to as a process thread. The vertical configuration facilitates vertical SIMD computations involving the processing of multiple data elements such as those found in image processing, three-dimensional graphics, and multi-dimensional data manipulations.

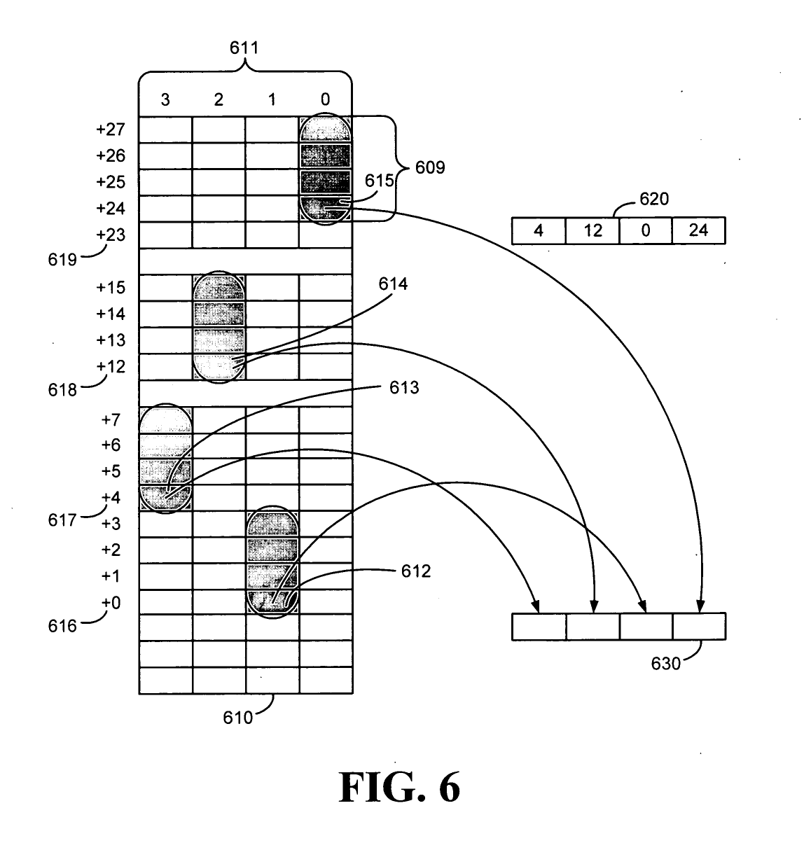

Reference is now made to FIG. 6, which is a block diagram illustrating an embodiment of an indexed register load operation illustrating a vertical operation from a register file. Data is stored in a register file 610 for subsequent processing. The register file 610 of some embodiments is a temporary or common register file for storing vector data corresponding to a computer graphics process. The vector data includes, for example, coefficient values for each of the dimensions 609 of the vector. Exemplary vectors 612, 613, 614, and 615 are stored in the register file 610 such that each vector is stored in a different one of the multiple vertical channels 611. The vectors 612-615 have corresponding offset values 616, 617, 618, and 619. The vector 612 in channel 1, for example, is used to establish a base address 616 for the relative addressing of the other vectors 612-614 such that the vector 612 has an offset value 616 that equals zero. The offset values 616-619 are selected to identify the component within each vector that is the closest to the base address 616. The offset values 616-619 are stored in an index register 620 such that each offset value is stored in an index register column corresponding to the register file vertical channel 611 where the vector was stored. The vectors 612 are received by the destination register 630 in a vertical configuration consistent with that of the register file 610. As each vector component is loaded into the destination register, the index value for that vector may be incremented to load the next vector component. In this case, the file register may have to be read for each component of each vector, such that four vectors each having four components may require sixteen registers to be read from the register file.

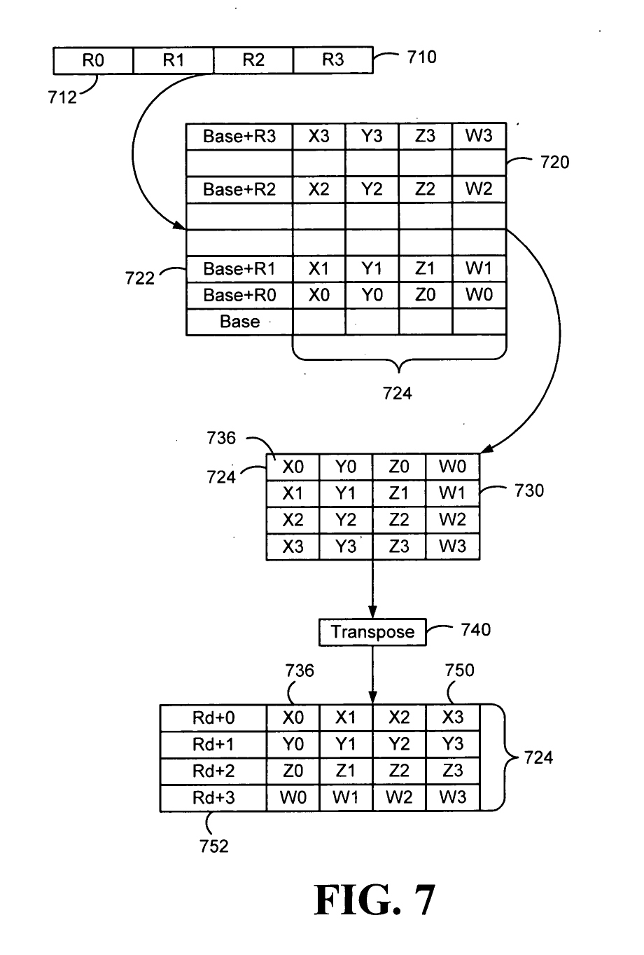

Reference is now made to FIG. 7, which is a block diagram illustrating another embodiment of an indexed register load operation. A register 710 contains four address values 712 having exemplary designations R0, R1, R2 and R3. Effective addresses 722 are generated by adding the address values 712 to a base address where the effective addresses 722 identify the locations of corresponding vectors 724. The vectors 724 are stored in a source data storage device 720 including, but not limited to, memory or a register. The vectors 724 corresponding to the effective addresses 722 are loaded into a temporary data storage location 730. The temporary data storage location 730 may be a physical memory location, a register, or may exist as a virtual device in program logic.

The vectors 724 in the temporary data storage location 730 are oriented in the same horizontal configuration as in the source data storage device 720 such that each row consists of the individual vector components 736 of each vector. The configuration of the four vectors 724, each having four vector components 736 creates a four-by-four matrix in the temporary data storage 730. A transposition function 740 is applied to the four-by-four matrix and the result is stored in a destination register 750. The four vectors 724 are stored in the destination register 750 at consecutive register addresses 752 in a vertical orientation such that each column contains a vector 724 and each row contains the same component value 736 for all of the vectors 724. In this manner, the vectors are configured for efficient vertical mode processing.

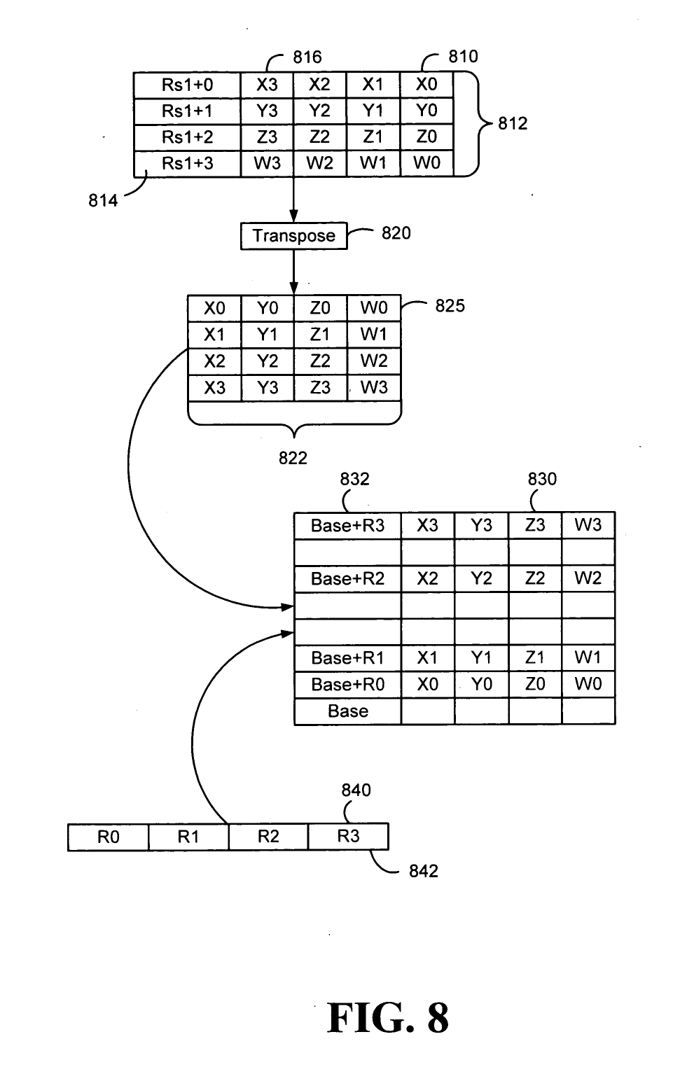

Reference is now made to FIG. 8, which is a block diagram illustrating an embodiment of an indexed register store operation. A register 810 includes four consecutive register addresses 814. Vector components 816 of four vectors 812 are stored in the register 810 such that each register address 814 corresponds to the same vector component 816 of four vectors 812. Thus each vector 812 is oriented vertically within the register 810. The configuration of the four vectors 812 each having four components 816 results in a four-by-four matrix. The four-by-four matrix is transposed 820 to generate a four-by-four matrix 825 having the vectors 822 in a horizontal orientation. The horizontally oriented vectors 822 are stored corresponding to effective addresses 832 in a data storage component 830. The data storage component 830 can be any addressable component for storing data including, but not limited to, memory and data registers. The effective addresses 832 can be determined by retrieving relative address values 842 from a separate register 840.

In summary, FIGS. 5-8 illustrate non-limiting examples of embodiments of the methods and systems herein. Where FIG. 5 illustrates horizontally oriented data stored in an array including but, not limited to a constant buffer, FIGS. 6-8 illustrate data stored in a register. Similarly, FIGS. 6 and 7 illustrate data as received by a destination register in a vertical orientation, the data of FIG. 6 is initially in a vertical orientation and requires no transposition, whereas the data of FIG. 7 is initially in a horizontal orientation and does require transposition prior to being received by the destination register. In contrast with FIGS. 5-7, FIG. 8 illustrates data originating in a register and being received by a data storage component. One of ordinary skill in the art will appreciate that the above described embodiments are merely exemplary and are not intended to limit the scope and spirit of the disclosure.

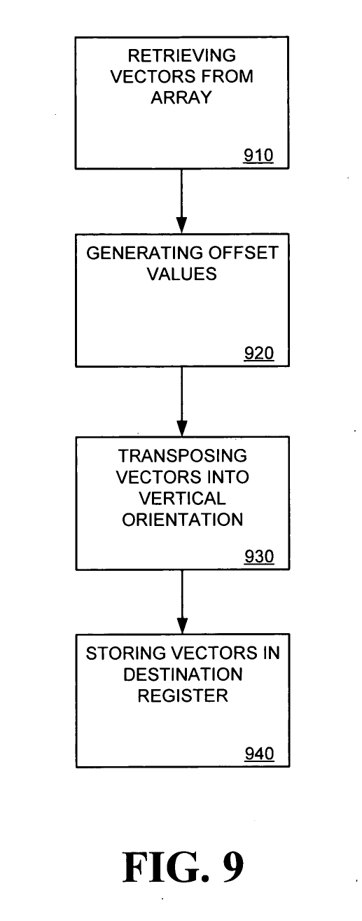

Reference is now made to FIG. 9, which is a block diagram illustrating an exemplary method as disclosed herein. In block 910 of the method, vectors are retrieved from an array. The array stores the vectors in a horizontal configuration such that each vector is stored in a different row of the array. The vectors include multiple components that are each stored in a different column of the array. In some embodiments, the vectors may be position vectors and include multiple components in the X, Y, Z, and W dimensions. The retrieving block 910 may include an accumulating function for gathering the vectors identified for processing. The accumulating function may be performed by storing the vector data in a memory location or by accommodating the vector data within processor logic. The retrieving block 910 may be performed by accessing the array once for each vector by reading the entire row of data.

Offset values related to a relative address of each vector are generated in block 920. The offset values provide array location information for each of the vectors relative to a base address. The base address may be a fixed reference within the array or may be assigned to an array location for a particular set of vectors. Any indexed or indirect operation will utilize the combination of the base address and the offset value to determine the actual location of data.

The horizontally-oriented vectors that are retrieved and accumulated are then transposed into a vertical orientation in block 930. The transposition entails converting the rows of horizontally oriented data into columns of vertically oriented data such that each column of transposed data represents one of the vectors. Accordingly, each row of transposed data represents a particular component of the vectors. In the vertical configuration, each of the offset values corresponds to one of the columns of data or vectors. After transposition, the vertically oriented data is stored in a destination register as shown in block 940. The vertical orientation of the data in the destination register permits the vectors to be processed in multiple parallel threads.

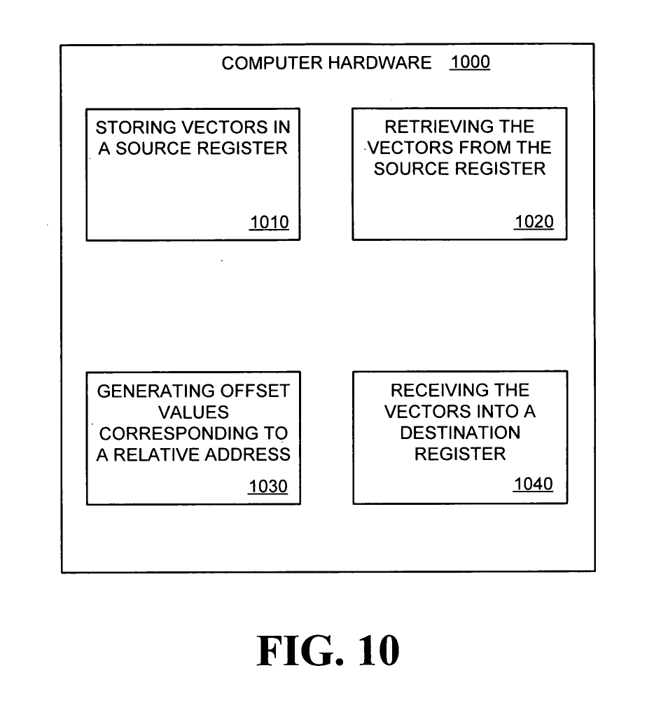

Reference is now made to FIG. 10, which is a block diagram illustrating exemplary computer hardware as disclosed herein. The computer hardware 1000 includes block 1010, which can be hardware, software or a combination thereof for storing vectors in a source register. The source register may be a register file including a temporary or common register file for storing vector data. The vector data includes, for example, coefficient values for each of the dimensions of the vector. The vectors are stored in the source register such that each vector is stored having the vector components arranged in a vertical configuration. The computer hardware 1000 also includes block 1030, which can be hardware, software, or a combination thereof for generating offset values corresponding to the relative addresses of the vectors. As discussed above, the offset value defines the difference between a base address and the location of the vectors in the source register. In some embodiments the location of one of the vectors serves as the base address such that the offset for that vector equals zero. The offset value may be stored in a specific register such as an index register.

Also provided is hardware, software, or some combination thereof for retrieving the vectors from the source register as shown in block 1020 and for receiving the vectors into a destination register as shown in block 840. Although retrieving the vectors and generating the offset values are essentially independent operations, the combined results from both are necessary to receive the vectors into a destination register. Since the destination register stores the vectors in a vertical configuration and the source register also uses a vertical configuration, there is no transposition requirement.

The methods of the present disclosure can be implemented in hardware, software, firmware, or a combination thereof. In some embodiments, the methods are implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process. Alternate implementations are included within the scope of an embodiment of the present disclosure in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

1. A computer system, comprising:
array logic configured to store a plurality of vectors, wherein each of the plurality of vectors comprises a horizontal array;
index logic configured to store offset data, relative to a base address, corresponding to each of the plurality of vectors;
loading logic configured to retrieve each of the plurality of vectors;
transposition logic configured to transpose the plurality of vectors into a vertical configuration using the offset data; and
register logic configured to receive the transposed plurality of vectors.

2. The computer system of claim 1, wherein the register logic comprises a plurality of vertical channels.

3. The computer system of claim 2, wherein the plurality of vertical channels are utilized in a plurality of parallel processes.

4. The computer system of claim 2, wherein a quantity of the plurality of vectors equals a quantity of the plurality of vertical channels.

5. The computer system of claim 4, wherein each of the plurality of vertical channels receives a corresponding one of the transposed plurality of vectors.

6. The computer system of claim 1, wherein the array logic is further configured to store each of the plurality of vectors in a row, wherein the row corresponds to one of a plurality of offset values.

7. The computer system of claim 6, the register logic further configured to store each of the plurality of vectors in a column.

8. The computer system of claim 7, wherein the column corresponds to the one of the plurality of offset values.

9. The computer system of claim 1, the loading logic further configured to retain a horizontal configuration.

10. The computer system of claim 1, wherein the plurality of vectors comprise position vectors.

11. The computer system of claim 1, the index logic further configured to generate a plurality of effective address values by adding each of a plurality of relative data address values to a fixed address value.

12. A method of indexed loading in a dual-mode computer processor, comprising:
retrieving a plurality of vectors from an array, the array comprising a plurality of array rows and a plurality of array columns and the array configured to store each of the plurality of vectors in one of the plurality of array rows;
generating a plurality of offset values, each of the plurality of offset values corresponding to a position of one of the plurality of rows relative to a base address;
transposing the plurality of vectors into a vertical orientation utilizing the plurality of offset values; and
storing the transposed plurality of vectors, wherein each of the plurality of vectors is configured as a corresponding one of a plurality of columns.

13. The method of claim 12, the generating comprising assigning each of the plurality of offset values to one of the plurality of register columns.

14. The method of claim 13, wherein each of the plurality of vectors is stored in the column corresponding to one of the plurality of offset values.

15. The method of claim 12, wherein the base address defines a specific one of the plurality of array rows.

16. The method of claim 12, the generating comprising storing the plurality of offset values in an index register.

17. The method of claim 12, wherein each of the plurality of columns comprises a process thread.

18. The method of claim 12, the retrieving comprising one access operation on the array for each of the plurality of vectors.

19. The method of claim 12, wherein the quantity of the plurality of vectors equals the quantity of the plurality of columns.

20. The method of claim 12, the retrieving comprising accumulating the plurality of vectors before transposing.

21. The method of claim 12, wherein each of the plurality of vectors comprises a position vector.

22. The method of claim 12, wherein each of the plurality of vectors comprises values for W, Z, Y, and X components.

23. The method of claim 12, the transposing comprising assigning each of the plurality of array rows to a corresponding one of the plurality of register columns.

24. The method of claim 12, further comprising processing data in a horizontal mode in the array and processing data in a vertical mode in the register.

25. The method of claim 24, wherein the vertical mode comprises parallel processing of the plurality of vectors.

26. The method of claim 12, further comprising generating a plurality of effective address values by adding each of a plurality of relative data address values to a fixed address value.

27. A computer processing apparatus for loading indexed operations in a dual-mode processing environment comprising:
a data array configured to store a plurality of data sets;
an index register configured to store a plurality of offset values corresponding to an address within the data array;
an accumulator configured to receive the plurality of data sets from the array; and
a destination register configured to receive the plurality of data sets in a transposed configuration.

28. The apparatus of claim 27, the data array comprising a plurality of array rows and a plurality of array columns.

29. The apparatus of claim 28, wherein each of the plurality of data sets comprises a plurality of components that correspond to the plurality of array columns.

30. The apparatus of claim 29, wherein each of the plurality of data sets is stored in one of the plurality of array rows configured to support horizontal mode processing.

31. The apparatus of claim 27, wherein the plurality of data sets are position vectors.

32. The apparatus of claim 27, wherein each of plurality of data sets comprise a plurality of components.

33. The apparatus of claim 27, wherein the plurality of components comprise W, Z, Y, and X coefficients.

34. The apparatus of claim 27, wherein each of the plurality of offset values corresponds to one of the plurality of data sets.

35. The apparatus of claim 34, wherein each of the plurality of offset values defines an address relative to a fixed base address.

36. The apparatus of claim 35, wherein the destination register comprises a plurality of register rows and a plurality of register columns and is configured to store each of the plurality of data sets in one of the plurality of columns, and wherein each of the plurality of rows corresponds to each of a plurality of data set components.

37. The apparatus of claim 27, further comprising logic configured to transpose each of the plurality of data sets from a horizontal orientation in the array to a vertical orientation in the destination register.

38. The apparatus of claim 37, wherein the destination register supports parallel processing of the plurality of data sets.

38. The apparatus of claim 27, wherein each of the plurality of offset values corresponds to one of the plurality of columns.

39. Computer hardware for loading indexed operations in a dual-mode processing environment, comprising:
means for storing a plurality vectors in a first register, wherein each of the vectors comprises a plurality of components and wherein the plurality of components are vertically oriented;
means for retrieving the plurality of vectors from the first register;
means for generating a plurality of offset values corresponding to the plurality of vectors; and
means for receiving the plurality of vectors into a second register, wherein each of the plurality of components within each of the plurality of vectors is received utilizing the corresponding one of the plurality of offset values.

40. A method of performing an indexed register load operation in a dual-mode processing environment, comprising:
reading a plurality of relative data address values from a first register;
generating a plurality of effective address values by adding each of the plurality of relative data address values to a fixed address value;
loading a plurality of vectors corresponding to the plurality of effective address values, each of the plurality of vectors comprising a plurality of vector components;
transposing the plurality of vectors by storing each of a plurality of rows associated with the plurality of vectors as a column and storing each of a plurality of columns associated with the plurality of vectors as a row; and
storing the transposed plurality of vectors in a second register.

41. A method of performing an indexed register store operation in a dual-mode processing environment, comprising:
transposing a plurality of vectors stored in a plurality of consecutively oriented addresses in a first register;
reading a plurality of relative address values from a second register;
generating a plurality of effective address values using the plurality of relative address values; and
storing the plurality of transposed vectors in a data storage component corresponding to the plurality of effective address values.

42. The method of claim 41, wherein the data storage component comprises memory.

43. The method of claim 41, wherein the data storage component comprises a third register.

44. The method of claim 41, wherein the generating comprises adding each of the plurality of relative address values to a base address value.
